(19) United States
(12) Patent Application Publication
(10) Pub. No.: US 2007/0195030 A1
(43) Pub. Date: Aug. 23, 2007

(54) LIQUID CRYSTAL DISPLAY PANEL UTILIZING REDUNDANCY LINE AS REPAIR LINE AND METHOD OF REPAIRING THE SAME

(75) Inventors: Chi-Ting Huang, Tainan County (TW); Wen-Tsung Lin, Tainan County (TW)

Correspondence Address: LOWE HAUPTMAN BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 11/677,390

(22) Filed: Feb. 21, 2007

(30) Foreign Application Priority Data
Feb. 21, 2006 (TW) 95105832

(51) Int. Cl. G09G 3/36

(52) U.S. Cl. 345/87

(57) ABSTRACT

A liquid crystal display panel utilizes a redundancy line as a repair line. The liquid crystal display panel has a substrate having data lines, and data drivers, which have plurality of data channels that have a plurality of corresponding data lines electrically connected to the data channels respectively. At least one data channel and corresponding data line are used as a repair line to perform data transmission. A memory stores information of the broken data line and the repair line. A timing controller coupled between the data drivers and the memory, utilizes the repair line instead of the broken data line to deliver an image data to the data channel and its corresponding data line to drive the liquid crystal display panel according to the information of the broken data line and the information of the repair line when the broken data line needs repair.

### RELATED APPLICATIONS

The present application is based on, and claims priority from, TW Application Number 95105832, filed Feb. 21, 2006, the disclosure of which is hereby incorporated by reference herein in its entirety.

### BACKGROUND OF THE PRESENT INVENTION

1. Field of Invention

The present invention relates to a liquid crystal display panel utilizing a redundancy line as a repair line and a method of repairing the same, and more particularly to a liquid crystal display panel utilizing a redundancy line as a repair line and a method of repairing the same to increase the yield of the liquid crystal display.

2. Description of Related Art

FIG. 1 is a schematic structure of a liquid crystal display (LCD) panel 100 showing a conventional method of repairing the disconnected data lines. As shown in FIG. 1, the LCD panel 100 comprises a substrate 12, an X-axial printed circuit board (X-board) 14, a Y-axial printed circuit board (Y-board) 16, and a flexible printed circuit board (FPC) 29 for electrically connecting the X-board 14 and the Y-board 16, wherein the X-board 14 and the Y-board 16 are used for transmitting signals to the substrate 12 to enable the LCD panel 100 to display images. The LCD panel 100 further contains a plurality of tape carrier packages (TCPs) 18 for electrically connecting the X-board 14 and the substrate 12, and a plurality of TCPs 20 for electrically connecting the Y-board 16 and the substrate 12. Each TCP 18 or 20 contains an integrated circuit (IC) chip (not shown in FIG. 1).

On the substrate 12 of the LCD panel 100, a display region has a plurality of horizontal scan lines S1˜Sm and a plurality of vertical data lines D1˜Dn to form an array of rectangular pixel regions. That is to say, a plurality of scan lines S1˜Sm are arranged in parallel to each other in horizontal direction, and a plurality of data lines D1˜Dn are arranged perpendicular thereto. The scan lines S1˜Sm and the data lines D1˜Dn are used for defining a plurality of pixels (not shown in FIG. 1) formed in matrix in an active region 26 on the substrate 12. Each of the scan lines S1˜Sm is electrically connected to its corresponding TCP 20 through a bonding pad 24, and similarly, each of the data lines D1˜Dn is electrically connected to its corresponding TCP 18 through a bonding pad 22. The substrate 12 further contains at least a repair line 28. The repair line 28 is set on the X-board 14, Y-board 16, and the substrate 12 for repairing the disconnected data line D1˜Dn on the substrate 12. Therefore, a signal will pass through the repair line 28 to every pixel when the X-board 14 outputs a signal to the data line Dn.

Referring to FIG. 2, FIG. 2 is a top view showing another conventional method using a repair line to repair the LCD panel 100 shown in FIG. 1. As shown in FIG. 2, if the data line Dn is disconnected at the point A, the prior art utilizes a laser fusing technique to repair the data line Dn by shorting its crossing points B and C with the repair line 28. Therefore, a signal will pass through the path 30 to every pixel when the X-board 14 outputs a signal to the data line Dn. However, the substrate 12 having the repair line 28 outside of the active area in closed loops would experience substantial electrical resistance when repairing a disconnected data line in the middle of active area since the signal path for sending signals to the data line below the disconnection becomes quite lengthy. In addition to large resistance, there would be a substantial parasitic capacitance increase since the repair line overlaps numerous data and scan lines, resulting in the increase of RC delay and signal distortion. As a result, the larger the size of the LCD panel 100 becomes, the greater the RC delay is.

FIG. 3 is a top view showing a further conventional method using a repair line to repair the LCD panel 100 shown in FIG. 1. As shown, if the data line Dn-1 is disconnected at the point A, the prior art utilizes a laser fusing technique to repair the data line Dn-1 by shorting its crossing points B and C with the repair line 32. Therefore, a signal will pass through the path 32 to every pixel when the X-boards 14a, 14b outputs a signal to the data line Dn-1. The repair line would not overlap numerous data lines D1˜Dn, resulting in the decrease of RC delay. However, in order to prevent the signal path for sending signals to the data line below the disconnection becomes quite lengthy, it is necessary to add an operational amplifier buffer (OP buffer) circuit disposed on the repair trace of the X-boards 14a, 14b, and the Y-board 16 for amplifying signals to the data line below the disconnection so as to prevent the signal distortion. Therefore, how to distribute and set the repair line on the X-board, Y-board, or the substrate to reduce the RC delay becomes a main issue for improving the yield of manufacturing an LCD panel with a large size. Additionally, it is necessary to utilize a class-A OP buffer to amplify signals to the data line below the disconnection so as to prevent the signal distortion. Thus, a higher manufacturing cost of the OP buffer is inevitable.

### SUMMARY OF THE PRESENT INVENTION

The present invention is firstly directed to providing a liquid crystal display panel utilizing a redundancy line as a repair line and a method of repairing the same which utilizes a timing controller and redundancy data channels of a data driver and its corresponding data line to determine at least one repair line to apply to the manufacturing of the liquid crystal display panel module in order to increase the yield of the liquid crystal display and effectively decrease the manufacturing cost.

The present invention is also directed to providing a liquid crystal display panel utilizing a redundancy line as a repair line and a method of repairing the same which utilizes a timing controller and redundancy data channels of a data driver and its corresponding data line to determine at least one repair line without the use of the OP buffer to repair the liquid crystal display. Even though there is no OP buffer to amplify signals, this will not result in the signal distortion transmitted by the repair line.

The present invention is additionally directed to providing a liquid crystal display panel utilizing a redundancy line as a repair line and a method of repairing the same which utilizes a timing controller and redundancy data channels of a data driver and its corresponding data line to determine at least one repair line to repair the liquid crystal display without any extra traces pre-disposed on the data drivers, the scan drivers, the X-board, or the Y-board.

The present invention is also directed to providing a liquid crystal display panel utilizing a redundancy line as a repair line and a method of repairing the same which utilizes a timing controller and a memory which stores the information of the repair line and the information of the broken data line to control the image data output in sequence in order to repair the liquid crystal display.

The present invention is further directed to providing a liquid crystal display panel utilizing a redundancy line as a repair line and a method of repairing the same which utilizes a plurality of redundancy data channels of a data driver and its corresponding data line to be served as a repair line instead of a broken data line to increase the yield of the liquid crystal display panel.

The present invention moreover directed to providing a liquid crystal display panel utilizing a redundancy line as a repair line and a method of repairing the same which utilizes a plurality of redundancy data channels of two ends of the data drivers and its corresponding data line to serve as a repair line instead of a broken data line.

The present invention is also directed to providing a liquid crystal display panel utilizing a redundancy line as a repair line and a method of repairing the same which utilizes a polarity generator electrically coupled to the timing controller for inverting polarities of signals of the data lines, Negative and Positive when the polarities of signals of the data lines are transmitted in the form of Positive and Negative.

The present invention is further directed to providing a liquid crystal display panel utilizing a redundancy line as a repair line and a method of repairing the same in which the weld is utilized to connect the broken data line to the corresponding even-numbered redundancy data line when the broken data line is the even-numbered data line.

The present invention is also directed to providing a liquid crystal display panel utilizing a redundancy line as a repair line and a method of repairing the same in which the weld is utilized to connect the broken data line to the corresponding odd-numbered redundancy data line when the broken data line is the odd-numbered data line.

The present invention is further directed to providing a liquid crystal display panel utilizing a redundancy line as a repair line and a method of repairing the same in which the data lines of the data channels having the same polarity are connected in parallel to drive the liquid crystal display panel so as to reduce RC effect when a power driving magnitude of the repair line is insufficient to drive the liquid crystal display panel.

The present invention is directed to providing a liquid crystal display panel utilizing a redundancy line as a repair line and a method of repairing the same in which the liquid crystal display further comprises a detection device to automatically detect the defect data line of the liquid crystal display panel to perform the repair process. The detection device can be a CCD camera, a CMOS camera, a line-scan camera, and a matrix camera.

Accordingly, in order to accomplish one or more of the above, the present invention provides a liquid crystal display panel comprising: a substrate comprising a plurality of data lines; a plurality of data drivers, each data driver comprising a plurality of data channels which have a plurality of corresponding data lines electrically connected to the data channels respectively, wherein at least one data channel and its corresponding data line are served as a repair line to perform data transmission; a memory for storing an information of a broken data line and an information of the repair line thereto; and a timing controller electrically coupled between the data drivers and the memory, wherein the timing controller utilizes the repair line instead of the broken data line to deliver an image data to the data channel and its corresponding data line to drive the liquid crystal display panel according to the information of the broken data line and the information of the repair line when the broken data line needs to repair.

One or part or all of these and other features and advantages of the present invention will become readily apparent to those skilled in this art from the following description wherein there is shown and described a preferred embodiment of this invention, simply by way of illustration of one of the modes best suited to carry out the invention. As will be realized, the invention is capable of different embodiments, and its several details are capable of modifications in various, obvious aspects all without departing from the invention. Accordingly, the drawings and descriptions will be regarded as being illustrative in nature and not restrictive with respect to the scope of the invention.

### BRIEF DESCRIPTION OF THE DRAWINGS

FIG. 1 is a schematic structure of a liquid crystal display (LCD) panel 100 showing a conventional method of repairing the disconnected data lines.

FIG. 2 is a top view showing a conventional method using a repair line to repair the LCD panel 100 shown in FIG. 1.

FIG. 3 is a top view showing another conventional method using a repair line to repair the LCD panel 100 shown in FIG. 1.

FIGS. 4a˜4b are schematic diagrams showing a method using a repair line to repair a LCD panel 200 if a data line A is disconnected at a point according to an embodiment of the present invention.

FIG. 5 is a schematic diagram showing a connection method using a repair line to repair the LCD panel 200 if a data line is disconnected according to the above embodiment of the present invention.

FIGS. 6a˜6b are schematic diagrams showing a driving method for effectively improving the defect data line of the LCD panel according to the above embodiment of the present invention.

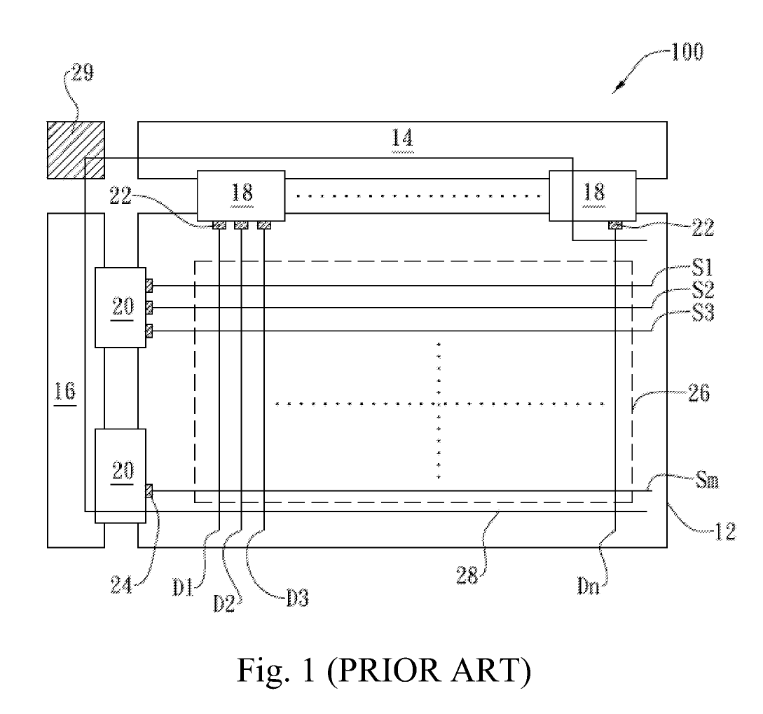

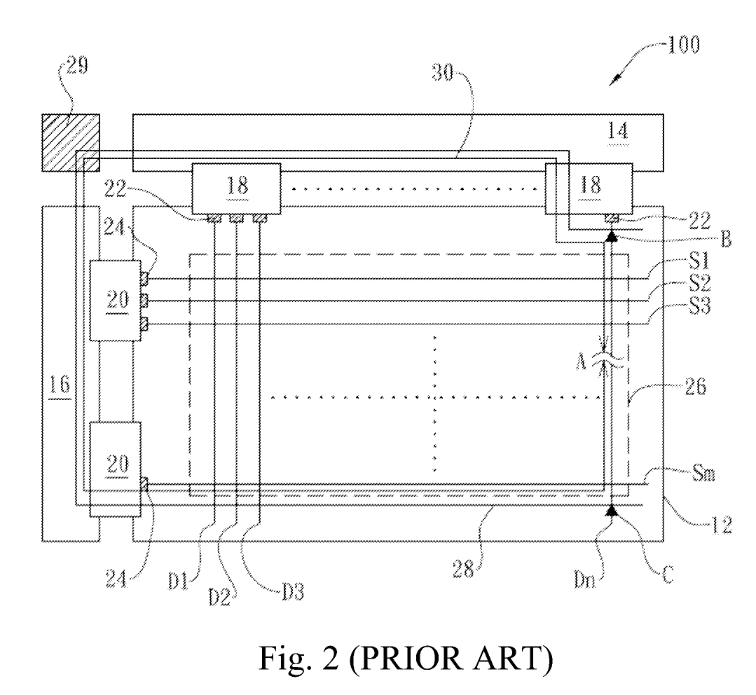

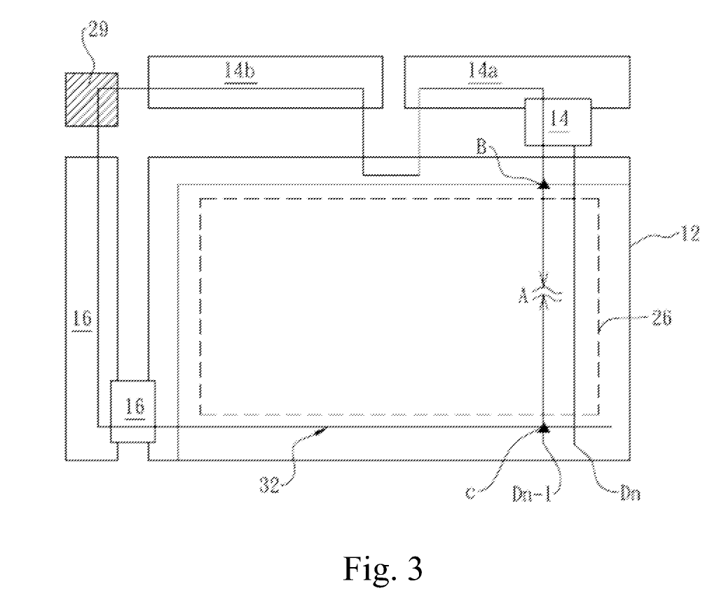

### DETAILED DESCRIPTION OF THE PREFERRED EMBODIMENT

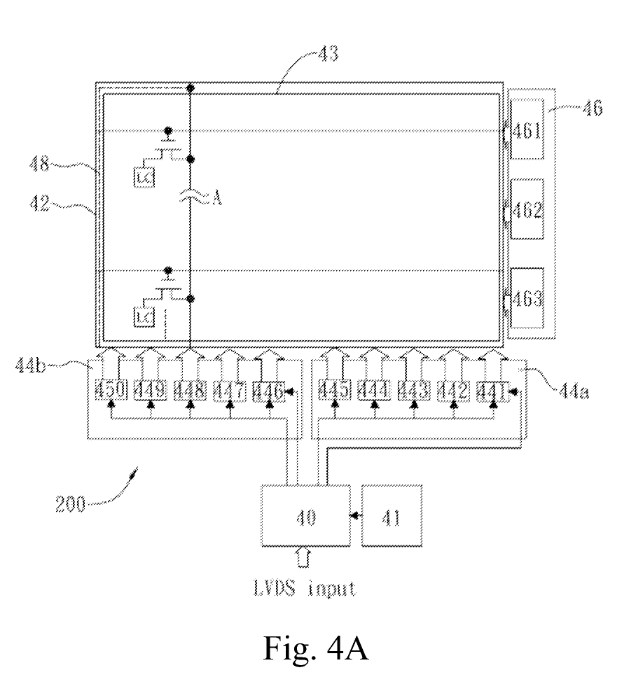

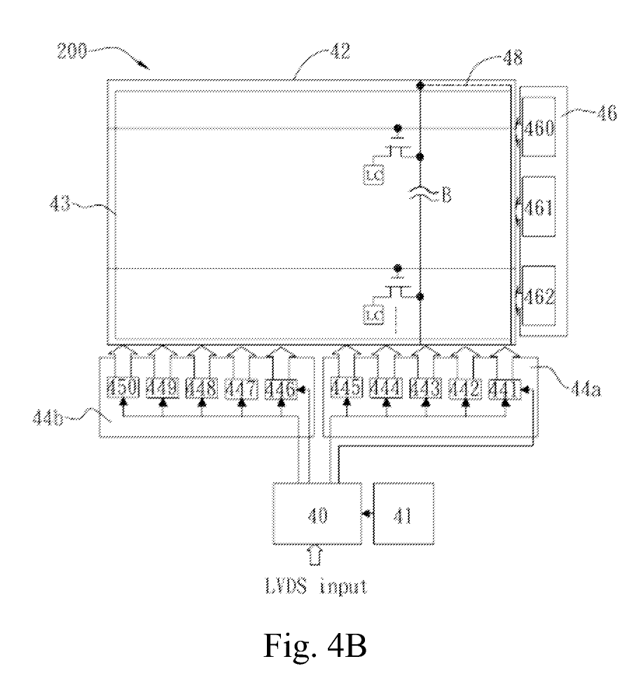

FIGS. 4a˜4b are schematic diagrams showing a method using a repair line to repair a LCD panel 200 if a data line A is disconnected at a point according to an embodiment of the present invention. As shown in FIGS. 4a˜4b, the LCD panel 200 comprises a substrate 42, two X-axial printed circuit boards (X-boards) 44a, 44b, and a Y-axial printed circuit board (Y-board) 46, wherein the X-boards 44a, 44b and the Y-board 46 are used for transmitting signals to the substrate 42 to enable the LCD panel 200 to display images.

On the substrate 42 of the LCD panel 200, a display region has a plurality of horizontal scan lines S1˜Sm (not shown in FIGS. 4a˜4b) and a plurality of vertical data lines D1˜Dn (not shown in figure) to form an array of rectangular pixel regions. That is to say, a plurality of scan lines S1˜Sm are arranged in parallel to each other in horizontal direction, and a plurality of data lines D1˜Dn are arranged perpendicular thereto. The scan lines S1˜Sm and the data lines D1˜Dn are used for defining a plurality of pixels (not shown in FIGS. 4a˜4b) formed in matrix in an active region 43 on the substrate 42 to produce images.

The substrate 42 further contains at least one repair line 48. The LCD panel 200 utilizes redundancy data channels of data drivers 441˜450 to implement the repair process by the repair line. That is to say, the data lines electrically connected to the redundancy data channels of data drivers 441˜450, are used to serve as the repair lines.

The data driver comprises a plurality of data channels. Generally speaking, the redundancy data channels of the leftmost data driver 441 or the rightmost data driver 450 of the data drivers 441˜450 (i.e. the first one data driver and the last one data driver) and the data lines electrically connected to the redundancy data channels of the leftmost data driver 441 or the rightmost data driver 450, are utilized to implement the repair process by the repair line.

In this embodiment, the LCD panel 200 further comprises a timing controller 40 and a memory 41. The timing controller 40 utilizes enable signals ASTH, BSTH to enable the plurality of the data drivers 441˜450 or the data drivers 446˜450 to store image data into the data drivers 441˜450 or the data drivers 446˜450.

The timing controller 40 and the memory 41 can be configured to utilize the redundancy data channels of the data drivers 441, 450 and corresponding data lines which are electrically to the redundancy data channels of the data drivers 441, 450, to establish at least one repair line 48 to repair the LCD panel 200 according to the known disconnected data line A and store the related information into the memory 41 to apply to the manufacturing of the display module of the LCD panel 200.

In other words, the timing controller 40 and the memory 41 are utilized to deliver image data to the data lines D1˜Dn to drive the LCD panel 200 and utilize the redundancy data channels of the data drivers 441, 450 and corresponding data lines which are electrically to the redundancy data channels of the data drivers 441, 450 to establish at least one repair line 48 to repair the LCD panel 200.

The method of repairing the LCD panel 200 is described as below. First, determine the broken data line A which needs to be repaired to obviate a defect in the LCD panel 200, by detecting the repair line 48 which will serve as a replacing wire to send a signal to the LCD panel 200 correctly when there is a disconnection in the data line A.

Second, store the information relating to the broken data line A and the repair line 48 into the memory 41. Then, configure the timing controller 40 to control the image data output in sequence to be sent into the data drivers according to the information stored in the memory 41. Accordingly, the repair line 48 can function as the replacing line in place of the broken data line A.

By utilizing the repair line 48 to perform the image data transmission enables an increase in the yield of the LCD panel. For example, once the data line A is disconnected (assume the 37th data line of the data driver 448 is disconnected), the timing controller 40 will utilize one of the redundancy data channels of the data driver 450 and the corresponding data line instead of the 37th data channel of the data driver 448 and the corresponding data line to enable at least one repair line 48 to perform the image data transmission in order to implement the repair process.

In this embodiment, as shown in FIG. 4b, the circuitry structure is similar to that in FIG. 4a. One difference is that the data driver 441 is utilized to implement the repair process. For example, once the data line B is disconnected (assume the 20th data line of the data driver 443 is disconnected), the timing controller 40 will utilize one of the redundancy data channel of the data driver 441 and the corresponding data line instead of the 20th data channel of the data driver 443 and the corresponding data line to determine at least one repair line 48 to perform the image data transmission in order to implement the repair process.

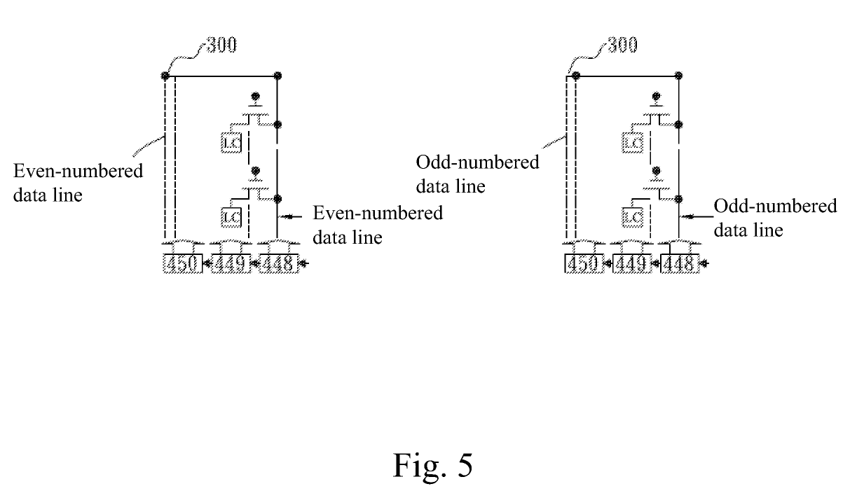

FIG. 5 illustrates a schematic diagram showing a connection method using a repair line to repair the LCD panel 200 if a data line is disconnected according to the above embodiment. As shown in FIGS. 5 and 4a, the LCD panel 200 further comprises a weld 300. The methods for inverting polarity in the driving methods for a conventional LCD panel are generally as described below.

The voltages applied on the liquid crystal molecules are divided into two types as positive voltages and negative voltages. There are four conventional methods for inverting polarity for an LCD panel. Generally speaking, the methods for inverting polarity include frame inversion, row inversion, column inversion, and dot inversion.

Each of the data lines respectively corresponds to multiple pixels. The pixels of each of the data lines are driven with a plurality of frame times, have a polarity distribution, and are processed one by one, and wherein the signals each have different polarities, Positive and Negative, that are applied to adjacent data lines.

The timing controller 40 sends a signal to the polarity generator to invert polarities, Negative and Positive, of the foregoing signals, which are applied to the adjacent data lines. Thus, the corresponding redundancy data line is connected to the broken data line by the weld 300. Furthermore, when the broken data line is the odd-numbered data line, which needs repair, the weld 300 is utilized to connect the broken data line to the corresponding odd-numbered redundancy data line. When the broken data line is the even-numbered data line, which needs to repair, the weld 300 is utilized to connect the broken data line to the corresponding even-numbered redundancy data line.

Additionally, the LCD panel 200 further comprises a detection device and a computer device. The detection device is utilized to automatically detect the defective data line of the LCD panel 200 and the computer device determines at least one redundancy data line as a repair line according to the detection information detected by the detection device. Then, the information of the known disconnected data line A and the repair line is stored into the memory. The timing controller of the computer device controls the image data output in sequence to be sent into the data drivers according to the information stored in the memory. Therefore, the repair line can be the replacing line instead of the broken data line A once the broken data line A is disconnected. By utilizing the repair line to perform the image data transmission the yield of the LCD panel can be increased.

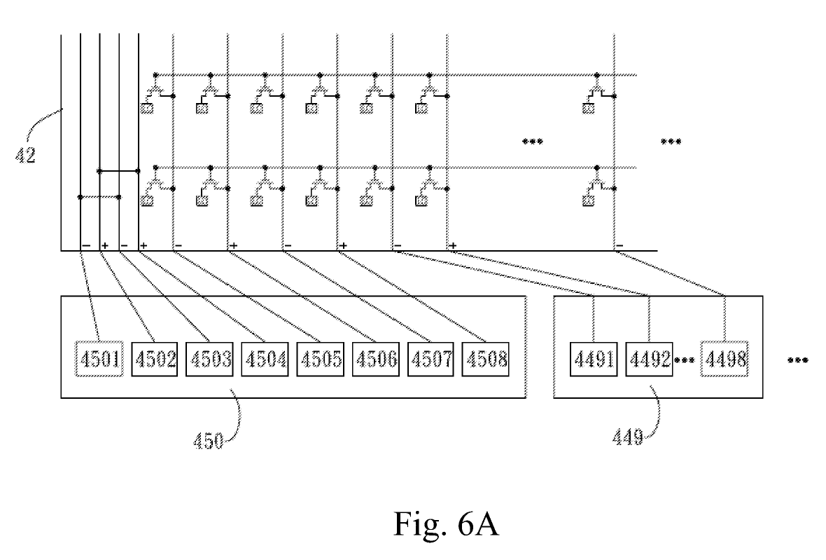

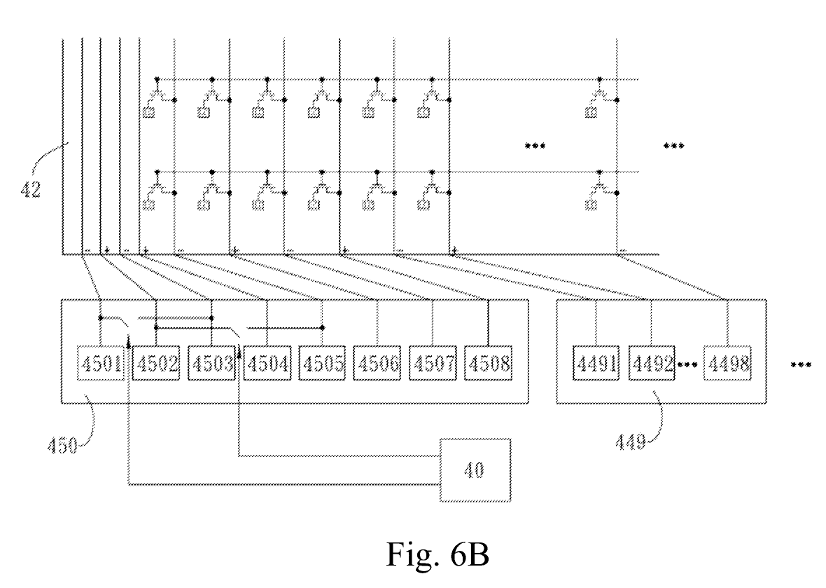

Furthermore, referring to FIGS. 6a˜6b, schematic diagrams showing a driving method to effectively obviate defective data line(s) of the LCD panel according to the above embodiment of the present invention, are illustrated. As shown in FIG. 6, the redundancy data channels 4501˜4504 of the data driver 450 having the same polarity can be connected in parallel to drive the LCD panel so as to effectively reduce the RC effect when the power driving magnitude is insufficient to meet the requirement to drive the LCD panel by the repair line 48. The corresponding redundancy data lines of the redundancy data channels 4501˜4504 having the same polarity can be connected in parallel to drive the LCD panel so as to effectively reduce the RC effect when the power driving magnitude may be insufficient to meet the requirement to drive the LCD panel by the repair line 48. In other words, by utilizing the data channels 4501, 4503 or at least two data line having the same polarity can be connected in parallel to drive the LCD panel so as to effectively reduce the RC effect and prevent the problem of a bright or weak line.

The parallel connection can be implemented by the layout of at least two data lines having the same polarity coupled in parallel in the X-axial printed circuit boards (X-boards) 44a, 44b (not shown in figure). As shown in FIG. 6b, the parallel connection can be implemented by the layout of at least two redundancy data channels having the same polarity coupled in parallel in the data driver 450 (not shown in figure), wherein the connection of the redundancy data channels can be controlled by the timing controller 40 or other programs. In addition, the detection device is an image capture device such as CCD camera, CMOS camera, line-scan camera, matrix camera, or the like.

In the aforementioned embodiment, the present invention utilizes the redundancy data channels of the data driver and the corresponding data lines to be served as a repair line to transmit the signals. The LCD panel can be divided into two block areas in order to prevent the signal path for sending signals to the data line below the disconnection, becoming quite lengthy. However, it is not intended to be exhaustive or to limit the invention to the precise form or to the aforementioned dividing block area technology disclosed. In other words, it is not intended to be exhaustive or to limit the invention to the precise form to implement the repair process to maintain the yield of the LCD panel without the aforementioned dividing block area technology.

One skilled in the art will understand that the embodiments of the present invention as shown in the drawings and described above, are exemplary and not intended to limit the scope of the invention.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments described above are chosen and described in order to best explain the principles of the invention and its practical application, thereby to enable persons skilled in the art to understand the invention for various embodiments and with various modifications as are suited to the particular use or implementation contemplated.

It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A repair system for a liquid crystal display panel comprising:
a data driver comprising a plurality of data channels which have a plurality of corresponding data lines electrically connected to the data channels respectively, wherein at least one data channel and its corresponding data line serve as a repair line to enable data transmission;
a memory for storing information of a broken data line and information of the repair line thereto; and
a timing controller electrically coupled between the data driver and the memory, wherein the timing controller utilizes the repair line instead of the broken data line to deliver image data through the data channel and its corresponding data line to drive the liquid crystal display panel according to the information of the broken data line and the information of the repair line, when image data are delivered through the broken data line to drive the liquid crystal display panel.

2. The repairing system, as recited in claim 1, further comprises a polarity generator electrically coupled to the timing controller for inverting polarities of signals of the data lines, Negative and Positive when the polarities of signals of the data lines are transmitted in the form of Positive and Negative.

3. The repairing system, as recited in claim 1, further comprises a weld electrically coupled to the polarity generator for connecting the broken data line to the data line which has the same polarity with that of the broken data line.

4. The repairing system, as recited in claim 1, wherein the data lines of the data channels having the same polarity, are connected in parallel to drive the liquid crystal display panel so as to reduce a RC (resistance capacitance) effect when a power driving magnitude of the repair line is insufficient to drive the liquid crystal display panel.

5. The repairing system, as recited in claim 1, further comprises a detection device electrically coupled to the timing controller for automatically detecting information of the broken data line in which the information of the broken data line is stored in the memory.

6. The repairing system, as recited in claim 5, wherein the detection device comprises one of a CCD camera, a CMOS camera, a line-scan camera, and a matrix camera.

7. A liquid crystal display panel comprising:
a substrate comprising a plurality of data lines;
a plurality of data drivers, each data driver comprising a plurality of data channels which have a plurality of corresponding data lines electrically connected to the data channels respectively, wherein at least one data channel and its corresponding data line are used as a repair line to perform data transmission;
a memory for storing an information of a broken data line and an information of the repair line thereto; and
a timing controller electrically coupled between the data drivers and the memory, wherein the timing controller utilizes the repair line instead of the broken data line to deliver an image data to the data channel and its corresponding data line to drive the liquid crystal display panel according to the information of the broken data line and the information of the repair line when the image data are delivered through the broken data line to drive the liquid crystal display panel.

8. The liquid crystal display panel, as recited in claim 7, wherein the liquid crystal display panel utilizes the data channel of one end of the data drivers and its corresponding data line to be served as the repair line to perform data transmission.

9. The liquid crystal display panel, as recited in claim 7, further comprises a polarity generator electrically coupled to the timing controller for inverting polarities of signals of the data lines, Negative and Positive when the polarities of signals of the data lines are transmitted in the form of Positive and Negative.

10. The liquid crystal display panel, as recited in claim 7, further comprising a weld electrically coupled to the polarity generator for connecting the broken data line to a data line which has the same polarity with that of the broken data line.

11. The liquid crystal display panel, as recited in claim 7, wherein the data lines of the data channels having the same polarity are connected in parallel to drive the liquid crystal display panel so as to reduce an RC (resistance capacitance) effect when a power driving magnitude of the repair line is insufficient to drive the liquid crystal display panel.

12. The liquid crystal display panel, as recited in claim 7, further comprises a detection device electrically coupled to the timing controller for automatically detect an information of the broken data line in which the information of the broken data line is stored in the memory.

13. The liquid crystal display panel, as recited in claim 12, wherein the detection device is one of a CCD camera, a CMOS camera, a line-scan camera, and a matrix camera.

14. A method for repairing a liquid crystal display panel, wherein the liquid crystal display panel comprises a data driver comprising a plurality of data channels which have a plurality of corresponding data lines electrically connected to the data channels respectively, comprising the steps of;
utilizing the data channel and its corresponding data line to be served as a repair line to perform data transmission; and
utilizing the repair line instead of a broken data line to deliver an image data to the data channel and its corresponding data line to drive the liquid crystal display panel according to an information of the broken data line and an information of the repair line when the image data are delivered through the broken data line to drive the liquid crystal display panel.

15. The method, as recited in claim 14, further comprising the step of: storing the information of the broken data line and the information of the repair line into a memory.

16. The method, as recited in claim 14, further comprising the step of: utilizing a polarity generator electrically coupled to the timing controller for inverting polarities of signals of the data lines, Negative and Positive when the polarities of signals of the data lines are transmitted in the form of Positive and Negative.

17. The method, as recited in claim 14, further comprising the step of: utilizing a weld electrically coupled to the polarity generator for connecting the broken data line to the data line which has the same polarity with that of the broken data line.

18. The method, as recited in claim 14, wherein the data lines of the data channels having the same polarity are connected in parallel to drive the liquid crystal display panel so as to reduce an RC effect when a power driving magnitude of the repair line is insufficient to drive the liquid crystal display panel.

19. The method, as recited in claim 15, further comprising:
utilizing a detection device electrically coupled to the timing controller for automatically detecting information relating to the broken data line; and
storing the information of the broken data line in the memory.

20. The method, as recited in claim 19, wherein the detection device comprises one of a CCD camera, a CMOS camera, a line-scan camera, and a matrix camera.
